(19) United States
(12) Patent Application Publication
(10) Pub. No.: US 2008/0025454 A1
(43) Pub. Date: Jan. 31, 2008

(54) Method for Operating a Reactor of a Nuclear Plant

(75) Inventors: Magnus Limback, Vasteras (SE); Kristina Ryttersson, Vasteras (SE); Sture Helmersson, Kolback (SE)

Correspondence Address: VENABLE LLP, P.O. BOX 34385, WASHINGTON, DC, 20043-9998, US

(73) Assignee: Westinghouse Electric Sweden AB, Vasteras (SE)

(21) Appl. No.: 11/629,497

(22) PCT Filed: Jun. 1, 2005
(86) PCT No.: PCT/SE05/00833

§ 371 Date: Dec. 14, 2006

(30) Foreign Application Priority Data
Jun. 14, 2004 (SE) 0401514-5

(51) Int. Cl. G21C 7/08

(52) U.S. Cl. 376/236

(57) ABSTRACT

A reactor of a nuclear plant encloses a core having a plurality of fuel elements and a number of control rods. Each fuel element includes a plurality of fuel rods each including a cladding and nuclear fuel enclosed in an inner space of the cladding. Each control rod is insertable to and extractable from a respective position between or in respective fuel elements to influence the effect of the reactor. A method for operating the reactor includes operating the reactor at a normal effect during a normal state, monitoring the reactor for detecting a defect on the cladding of any fuel rod, reducing the effect of the reactor after the detection of a defect, operating the reactor during a particular state during a time period during which the reactor at least during a part time is operated at the reduced effect in relation to the normal effect, and extracting the inserted control rods after the time period for continuing operation of the reactor at substantially the normal state.

### BACKGROUND OF THE INVENTION AND PRIOR ART

The present invention refers a method for operating a reactor of a nuclear plant. The reactor is a light water reactor and more precisely a boiling water reactor, BWR, or a pressure water reactor, PWR.

Such a reactor includes a reactor vessel enclosing a core having a plurality of fuel elements and a number of control rods. Each fuel element includes a plurality of fuel rods, which each includes a cladding and nuclear fuel in the form of a pile of fuel pellets of substantially uranium dioxide. The fuel pellets are enclosed in an inner space formed by the cladding. The fuel pellets do not fill the whole inner space but there is also a free volume in the inner space in which the fuel pellets are permitted to swell, i.e. through thermal expansion. The free volume, i.e. the inner space which is not filled by fuel pellets, is filled with a fill gas. Each of the control rods is insertable to and extractable from a respective position between (BWR) or in (PWR) respective fuel elements in the core in order to influence the effect of the reactor.

During unfortunate circumstances it may happen that a smaller defect arises on the cladding of the fuel rod, a so called primary defect. Such a primary defect can arise through wear from a foreign object. A small wear defect normally does not result in any significant dissolving and washing out of the uranium pellets of the rod. A small primary defect may however result in a secondary degradation and the development of a larger secondary defect.

When a primary defect has been developed there is a communication passage between the inner space of the rod and the coolant water of the reactor. This means that water and steam may penetrate the inner space of the fuel rod until the internal pressure of the rod is the same as the system pressure of the reactor. During this process the inner side of the cladding and the fuel pellet oxidise while releasing hydrogen from the water molecules in the coolant water. This leads in its turn to an environment with a very high partial pressure of hydrogen at a distance from the primary defect; a phenomenon which is called “oxygen starvation” or “steam starvation”. In such an environment the inner side of the cladding is inclined to absorb hydrogen very quickly, so called hydrogenation, which is a basic material property of zirconium and zirconium-based alloys. This result in a locally very high hydrogen concentration in the cladding, which in its turn significantly deteriorates the mechanical properties of the cladding. The cladding becomes very brittle and this can due to self-induced stresses or due to external load give rise to crack inducing, crack growth and the development of a secondary fuel defect.

During normal operation of the reactor at principally full effect, a primary defect may, as appears from above, arise in a fuel rod. It can then be assumed that the defect fuel rod has an average load of for instance 20 kW/m, a certain pellet-cladding-gap, for instance 5-20 μm, and an internal pressure of for instance 5-100 bars. The internal pressure in fuel rods for boiling water reactors lies during operation in the lower region of the interval, whereas the internal pressure in fuel rods for pressure water reactors during operation can lie in the upper region of the interval. When the primary defect arises, the pressure difference between the internal pressure of the fuel rod and the system pressure will disappear, i.e. the internal pressure of the fuel rod will be the same as the system pressure. The system pressure in a boiling water reactor is typically about 70 bars, whereas the system pressure in a pressure water reactor typically is about 150 bars. When this occurs, the fill gas, which normally substantially consists of helium and fission gases from the fuel pellets, will be moved towards both the ends of the fuel rod, whereas steam is introduced until the internal pressure of the fuel rod is the same as the system pressure. Before the radiation is initiated the fill gas of the fuel rod normally substantially consists of helium and the internal pressure of the fuel rod is at room temperature typically 1-40 bars. The internal pressure in fuel rods for boiling water reactors typically lies in the lower region of the interval, whereas the internal pressure in fuel rods for pressure water reactors normally lies in the upper region of the interval. As mentioned above, the steam will during this process react with the cladding and the fuel pellets during release of hydrogen from the water molecules which react with the cladding or the fuel pellets. This means that an area with a very high partial pressure of hydrogen can be obtained at a distance from the primary defect. It is thus possible to imagine that very soon after the occurrence of the primary defect an area with fill gas at each of the two ends of the fuel rod has been formed. The free volumes, which are present directly adjacent to the ends, may initially contain substantially pure hydrogen gas, mixed with inert gases but free from steam. In this areas, where the partial pressure of hydrogen directly after the primary defect is very high, the risk for secondary degradation is high. If the partial pressure of hydrogen sinks and the partial pressure of steam increases, the local massive hydrogen absorption will decrease and the hydrogen absorption can take place more homogeneously over the inner side of the cladding wall, which reduces the risk for local secondary degradation.

U.S. Pat. No. 5,537,450 discloses a device for detecting whether there is a fuel defect. The device is arranged to detect fuel defects during operation of the reactor by conveying a part of the off-gases from the reactor via a gamma spectrograph that continuously measures the nuclide composition and the activity level in the off-gases. It is also known to localise a fuel defect by a method called “flux-tilting”, which means that the control rods are controlled one at the time so that the effect is changed locally in the core at the same time as the activity level in the off-gases is measured. An increase of the activity level in the off-gases can be recognized at control rod movements in the proximity of the fuel defect. In such a way the fuel defect can be localized. This method is time-consuming and during the time when the localization takes place the effect of the reactor is reduced to between 60 and 80% of full effect.

### SUMMARY OF THE INVENTION

The object of the present invention is to counteract degradation of a possible primary defect and thus reduce the risk of a secondary defect during a continuing operation of the reactor.

This object is achieved by the method defined in claim 1.

Since the reactor, when a primary defect has been detected, during the particular state at least periodically is operated at a reduced effect, the nuclear reaction in the fuel will decrease and thus the temperature in the fuel pellets decreases, which reduces the thermal expansion of the fuel pellets. In such a way the free volume in the inner space of the fuel rod increases. This means that further steam may penetrate the inner space of the fuel rod for maintaining the pressure equalisation between the inner space of the fuel rod and the system pressure. In addition, the reaction rates for the oxidation of the cladding and the fuel pellets will as well as for the hydrogenation of the cladding decrease when the reactor effect is reduced and the fuel temperature decreases.

Since the defect fuel rod during the defined time period has a substantially lower fuel pellet temperature and a substantially larger free volume in the inner space, the gases, i.e. the fill gas, formed fission gases, hydrogen gas and steam, will be mixed through diffusion. Diffusion takes of course also place at higher pellet temperatures but the oxidation and hydrogenation rates may then be so high that the diffusion will have an insignificant importance in comparison to the gas movements arising due to the pressure difference between the different parts of the fuel rod.

Consequently, the present invention lies in the achievement of the gas mixture via diffusion being the dominating mechanism by significantly decreasing the consumption of oxygen and hydrogen in the fuel rod. During these conditions we may thus obtain a gas mixture in the inner space at the same time as the hydrogenation is relatively slow. When a proper mixture of hydrogen and water molecules has been obtained in the inner space of the fuel rod, the hydrogen absorption at a continuing operation will take place more homogeneously along the whole fuel rod and it is thus possible to avoid the creation of a zone of the cladding that has significantly degraded mechanical properties as a consequence of a powerful local hydrogenation.

The homogeneous hydrogen distribution makes the fuel rod significantly less sensible to crack inducing, crack growth and the development of a secondary defect. Consequently, the limited time period, during which the reactor is operated at least periodically reduced effect, leads to the very significant increase of the probability that the reactor with the same set of fuel rods thereafter can be operated until the next scheduled normal revision shut down without any additional shut downs for removing defect fuel and without requiring the introduction of control rods for locally reducing the effect in the region of the core where the defect fuel rod is located. This method may thus offer a significant economic advantage in comparison to the measures normally used today.

According to a further development of the method according to the invention, said reducing of the effect is obtained through inserting at least some of said control rods to the respective position in the core. Such an effect reduction can take place very quickly and lead to a quick decrease of the temperature of the fuel pellets, which decreases their volume and thus increases the free volume in the inner space of the defect fuel rod.

According to a further development of the method according to the invention, substantially all control rods are at least periodically inserted into the respective position in the core during the particular state, wherein a particularly significant effect reduction is obtained.

According to a further development of the method according to the invention, said reducing of the effect is obtained through successive inserting of different groups of said control rods to the respective position in the core, wherein each such group defines a respective specific part of the core. The particular state may thus also be established for different parts of the core in successive periods. Individual control rods or groups of control rods may then be used for the effect reduction. This permits identification of the position of the defect fuel rod and limits the necessary effect reduction.

According to a further development of the method according to the invention, said reducing of the effect is performed at least within 72 h, preferably within 48 h and more preferably within 24 h after the detection of a defect. Advantageously, said reducing of the effect is performed substantially immediately after the detection of a defect. It is advantageous if the effect reduction takes place quickly so that the desired mixture in the inner space is obtained as soon as possible after the occurrence of a defect.

According to a further development of the method according to the invention, the reactor is operated at the reduced effect during the whole time period.

According to a further development of the method, the particular state involves that at least some of the control rods are alternately inserted into and extracted from the respective position for obtaining an alternating increase and decrease of the effect. This may be advantageous when the position of the defect fuel rod has been identified.

According to a further development of the method according to the invention, said monitoring includes continuous monitoring during the operation of the reactor. The monitoring may then advantageously include sensing of the presence of one or several fission gases in an off-gas flow from the reactor.

### BRIEF DESCRIPTION OF THE DRAWINGS

The present invention is now to be explained more closely by means of an embodiment that is disclosed as an example and with reference to the drawings attached hereto, in which

FIG. 1 discloses schematically a nuclear plant and

FIG. 2 discloses schematically a longitudinal section through a fuel rod.

### DETAILED DESCRIPTION OF VARIOUS EMBODIMENTS

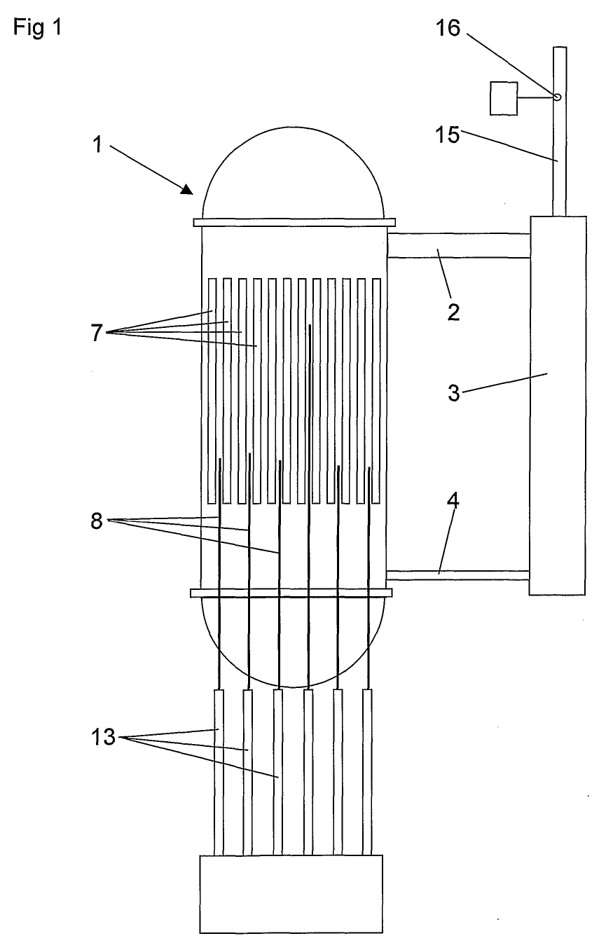

FIG. 1 discloses a nuclear plant including a reactor 1, a discharge conduit 2 from the reactor 1, a utility device 3 and a feedback conduit 4 from the utility device 3 back to the reactor 1. The reactor 1 may be a boiling water reactor, BWR, or a pressure water reactor, PWR. In the example disclosed, it is referred to a boiling water reactor although the invention is applicable also to a pressure water reactor.

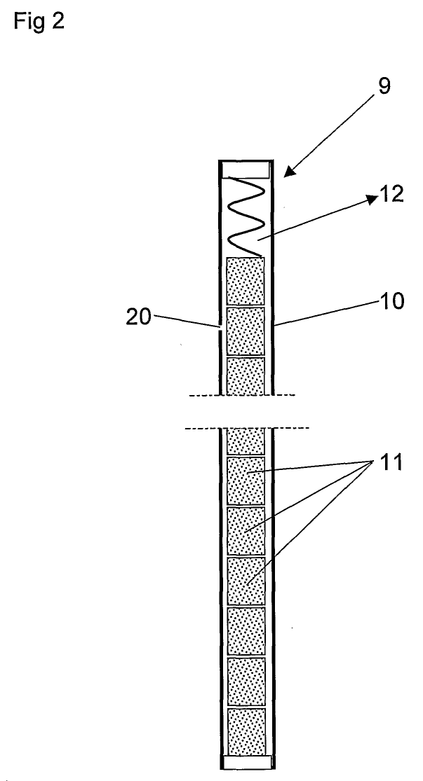

The reactor 1 encloses a core with a plurality of fuel elements 7 and a number of control rods 8. Each fuel element 7 includes a plurality of fuel rods 9, see FIG. 2, which each includes a cladding 10 and nuclear fuel in the form of a pile of fuel pellets 11 which are enclosed in an inner space 12 formed by the cladding 10. Since the fuel pellets 11 does not take up the whole inner space 12 a free volume is formed in the inner space 12 of the cladding 10. The size of the free volume varies with the temperature of the fuel pellets 11 and thus with the thermal expansion of the fuel pellets 11.

Each of the fuel rods 8 is insertable to and extractable from a respective position between respective fuel elements 7 in the core by means of drive members 13. The control rods 8 can be used for influencing or controlling the effect of the reactor 1. When the control rods 8 are extracted the nuclear chain reaction proceeds and when the control rods 8 are inserted the nuclear chain reactor stops at least in the proximity of the inserted control rods 8. During normal operation of the reactor, most of the control rods 8 are extracted, compare FIG. 1.

In a boiling water reactor steam will during normal operation be produced by the coolant water circulating in the plant. The steam is conveyed through the discharge conduit 2 to the utility device 3 which may include a steam turbine and a condenser, not specifically disclosed. From the condenser, the condensed coolant water is conveyed back to the reactor 1, via the feedback conduit 4. The plant also includes an arrangement for catching and removing off-gases produced in the reactor 1. This arrangement may include an off-gas conduit 15. In the off-gas conduit 15 a sensor 16 may be provided. The sensor 16 is arranged to detect a nuclear activity and nuclides formed at the reaction in the fuel rods. If a defect arises on a cladding 10, fission gases will leak out and be conveyed out through the off-gas conduit 15. These fission gases include such radioactive nuclides that can be detected and give substantially immediate information saying that a primary defect has occurred.

According to an embodiment, the reactor 1 may be operated at a normal effect, i.e. normally full effect, during a normal state. During this normal operation, the reactor 1 is monitored for instance continuously by means of the sensor 16 for detecting a possible defect on the cladding 10 of any of the fuel rods 9 in the core. The possible defect may be a primary defect which for instance has been caused by mechanical wear. The defect is indicated in FIG. 2 at 20.

If such a defect 20 has been detected, the effect of the reactor 1 is reduced. The effect reduction is made at least within 72 h, preferably within 48 h or more preferably within 24 h after the detection of the defect 20. Advantageously, the effect reduction is made as soon as possible, for instance substantially immediately after the detection of the defect 20. This effect reduction is obtained through insertion of substantially all control rods 8 by means of the drive members 13, wherein the chain reaction is reduced and thus the effect and temperature of the fuel pellets 11 in the fuel rods 9 decrease. By means of this measure a so called hot shut down is obtained, which means that the chain reaction substantially ceases but that the system pressure in the reactor 1 and the temperature of the coolant water in the reactor 1 are substantially maintained.

The reactor 1 is then operated further with the control rods 8 inserted during a particular state which exists during a limited time period. The length of this limited time period may vary depending on a plurality of different factors, such as the size of the reactor 1, how many control rods 8 that has been inserted etc. During this time period, the effect is thus substantially reduced in relation to the normal full effect. The time period has to have at least such a length that the temperature of the fuel pellets decreases significantly. The limited time period may for instance rest from parts of an hour of some hours to 1, 2, 3 or 4 days. For instance, the limited time period may be at least 10, 20, 30, 40 or 50 minutes, or 1, 2, 3, 4, 5, 6, 7, 10, 14, 20 or more hours. The limited time period may maximally be 4, 3, 2 or 1 days.

By means of such an effect reduction, the thermal expansion of the fuel pellets 11 will decrease and the free volume in the inner space 12 of the defect fuel rod 9 will increase. This volume increase means that further steam will penetrate the inner space 12 so that the pressure equalization between the inner space 12 and the system pressure is maintained. Furthermore, the lower temperature of the fuel pellets 11 means that the reaction rate for the oxidation of the cladding 10 and the fuel pellets 11 as well as for the hydrogenation of the cladding 10 decrease. The lower fuel pellet temperature and the larger free volume also means that the gases, i.e. the fill gas, fission gases, hydrogen gas and steam, in the inner space 12 will be mixed through diffusion. Thanks to such a mixing of hydrogen and water molecules in the inner space 12, the hydrogen absorption during continuing operation will take place more homogeneously along the whole fuel rod 9 and not be concentrated to a smaller local zone of the cladding 10.

Substantially immediately after this time period, when the equalization has taken place, the inserted control rods 8 may again be extracted for continuing operation of the reactor 1 at substantially full effect and with the same set of fuel rods 8, i.e. the defect fuel rod 8 may be maintained in the core until the next scheduled shut down for fuel exchange.

It is to be noted that it may be possible during the defined time period to insert merely some of the control rods 8 to the respective position. The particular state may also be established for parts of the core in successive periods, wherein said reduction of the effect is obtained through successive insertion of various groups of said control rods to respective position in the core.

Each such group then advantageously defines a specific part of the core. It is also possible to imagine insertion of more than half of the control rods 8 for obtaining an effect reduction influencing a greater fraction of the fuel elements of the reactor.

According to a variant of the method the particular state includes that at least some or substantially all control rods 8 alternately are inserted to or extracted from the respective position for obtaining an alternating increase and decrease of the effect. In such away, the temperature and the thermal expansion of the fuel pellets 11 will also increase and decrease in an alternating manner, which means that the mixing of the gases in the inner space is accelerated.

The invention is not limited to the embodiments disclosed but may be varied and modified within the scope of the following claims.

1. A method for operating a reactor of a nuclear plant in which the reactor encloses a core having a plurality of fuel elements and a number of control rods,
wherein each fuel element includes a plurality of fuel rods, which each includes a cladding and nuclear fuel enclosed in an inner space formed by the cladding,
wherein each of the control rods is insertable to and extractable from a respective position between respective fuel elements in the core in order to influence the effect of the reactor,
wherein the method comprises:
operating the reactor at a normal effect during a normal state,
monitoring the reactor for detecting a defect on the cladding of any of the fuel rods,
reducing the effect of the reactor after detecting such a defect, wherein said reducing of the effect is obtained through inserting at least some of said control rods to the respective position in the core, operating the reactor during a particular state during a limited time period during which the reactor at least periodically is operated at the reduced effect in relation to the normal effect, and
extracting said inserted control rods after said time period for continuing operation of the reactor at substantially the normal state.

2. The method according to claim 1, wherein substantially all control rods are at least periodically time inserted to the respective position in the core during the particular state.

3. The method according to claim 1, wherein said reducing of the effect is obtained through successive inserting of different groups of said control rods to the respective position in the core, wherein each such group defines a respective specific part of the core.

4. The method according to claim 1, wherein said reducing of the effect is performed at least within 72 hours after the detection of a defect.

5. The method according to claim 1, wherein said reducing of the effect is performed at least within 48 hours after the detection of a defect.

6. The method according to claim 1, wherein said reducing of the effect is performed at least within 27 hours after the detection of a defect.

7. The method according to claim 1, wherein said reducing of the effect is performed substantially immediately after the detection of a defect.

8. The method according to claim 1, wherein the reactor is operated at the reduced effect during the whole time period.

9. The method according to claim 8, wherein substantially all control rods are inserted into the respective position in the core during the whole time period.

10. The method according to claim 1, wherein the particular state involves that at least some of the control rods are alternately inserted into and extracted from the respective position for obtaining an alternating increase and decrease of the effect.

11. The method according to claim 1, wherein said monitoring includes continuous monitoring during the operation of the reactor.

12. The method according to claim 9, wherein the monitoring includes sensing of a radioactive activity in a gas flow from the reactor.
